(19) United States
(12) Patent Application Publication
(10) Pub. No.: US 2023/0385711 A1
(43) Pub. Date: Nov. 30, 2023

(54) WEIGHT BALANCING FUNCTION FOR A CONFIGURABLE PARTICIPANT-INPUT PORTAL

(71) Applicant: Peek Travel Inc., Cottonwood Heights, UT (US)

(72) Inventors: Oskar Bruening, Lakewood, OH (US); Sara E. Wilson, South Jordan, UT (US); Gregory Coladarci, Alameda, CA (US)

(21) Appl. No.: 17/829,022

(22) Filed: May 31, 2022

(51) Int. Cl. G06Q 10/02; G06Q 10/06; G06Q 50/30; G01G 19/00

(52) U.S. Cl. CPC G06Q 10/02; G06Q 10/06395; G06Q 50/30; G01G 19/00

(57) ABSTRACT

Devices, systems, methods, and computer-readable media for providing by a third party device a weight balancing function to an activity operator. One method includes providing to an activity operator, by a third party device, an activity operator access portal to allow the activity operator to configure an activity participant-input portal that allows an activity participant to reserve a spot from a number of available spots open for an activity and enter information about the participant therein, providing, by a third party device, a weight balancing function to an activity operator to determine weight balancing for a number of passengers, crew, and equipment of a helicopter for a helicopter flight.

### FIELD OF THE PRESENT DISCLOSURE

Devices, systems, methods, and computer-readable media for providing to a prospective activity participant a weight balancing function for a configurable participant-input portal. In particular, the present application describes concepts involving weight balancing by a third party via a configurable helicopter flight participant-input portal, wherein the helicopter flight participant-input portal is configured by the helicopter flight activity operator via an helicopter flight activity operator-input portal that is created by a third party and accessible through a third party device, and information about the helicopter flight activity is configured to indicate to the prospective helicopter flight activity participant that the helicopter flight activity is available during a particular day and time that is configured by the helicopter flight activity operator.

### BACKGROUND

People enjoy participating in a variety of activities. These activities could be local activities or activities that require travel. Such activities could also be a variety of different kinds of activities and can include tours. The activities may include, but are not limited to, sightseeing tours, food tours, vehicle tours or rentals, such as by helicopter, boat, car, bus, bicycle, Segway, scooter, etc., and other activities organized by an organizing entity wherein a participant will need to sign up to participate or sign up to reserve equipment with that organizing entity. As technology has changed, people have used different avenues to search for and reserve spots for tours.

As the Internet has grown, it has made many aspects of people's lives easier and more convenient. Booking tours is one of those aspects. Websites have been created for the purpose of helping people search for and book tours. Some of these websites can be referred to as activity booking portals. Activity booking portals allow people to search for and book different activities.

Activity booking portals add convenience for participants. One way activity booking portals add convenience to participants is that it allows participants to more easily find tours. This is accomplished by allowing participants to search for the type of tour they want. Activity booking portals allow participants to search for a type of tour, location of a tour, price of a tour, duration of a tour, etc. Some activity booking portals also allow people to write participant reviews and read reviews from other participants. In this regard, many activity booking portals provide participants with a convenient website to conduct various aspects of planning and booking activities.

These activity booking portals also provide convenience for the activity operators. Putting their tours on these activity booking portals allows more potential participants see their tours than if the activity operator only had the tour viewable on its own private website and promotional materials. As a result of having more people view the tour listing, activity booking portals allow the activity operator to inform more people about the tours available and what occurs during each type of tour. This may attract participants to a specific tour that were not originally looking for that specific tour.

Helicopter flights can be difficult for booking sites as the number of available seats can change based on weight of the participant and their baggage and location of that participant and baggage on the helicopter. Accordingly, typical booking sites for such helicopter activities can be overbooked which may make the trip unsafe.

### BRIEF DESCRIPTION OF THE DRAWINGS

FIG. 1 illustrates a functional block diagram of a computing system including at least one memory array featuring instructions for a weight balancing function for a configurable participant-input portal configured according to embodiments of the present disclosure.

FIG. 2 is a screenshot of activity operator-configurable parameters for weight balancing displayed on the participant-input portal configured according to embodiments of the present disclosure.

FIG. 3 is a screenshot of activity operator-configurable parameters for weight balancing displayed on the activity operator-input portal configured according to embodiments of the present disclosure.

FIG. 4 is a screenshot of additional activity operator-configurable parameters for weight balancing displayed on the activity operator-input portal configured according to embodiments of the present disclosure.

FIG. 5 is a screenshot of a report displayed on the activity operator-input portal of an initial weight balancing analysis for takeoff and landing weight balancing calculations configured according to embodiments of the present disclosure.

FIG. 6 is a screenshot of another report displayed on the activity operator-input portal of an initial weight balancing analysis for takeoff and land weight balancing calculations configured according to embodiments of the present disclosure.

FIG. 7 is a depiction of an example of a center of gravity analysis performed according to embodiments of the present disclosure.

FIG. 8 is another depiction of an example of a center of gravity analysis performed according to embodiments of the present disclosure.

FIG. 9 is another depiction of an example of a center of gravity analysis performed according to embodiments of the present disclosure.

FIG. 10 is another depiction of an example of a center of gravity analysis performed according to embodiments of the present disclosure.

FIG. 11 is another depiction of an example of a center of gravity analysis performed according to embodiments of the present disclosure.

FIG. 12 is a screenshot of a report displayed on the activity operator-input portal of a center of gravity analysis of weight balancing calculations configured according to embodiments of the present disclosure.

FIG. 13 is a screenshot of another report displayed on the activity operator-input portal of a center of gravity analysis of weight balancing calculations configured according to embodiments of the present disclosure.

FIG. 14 is a screenshot of another report displayed on the activity operator-input portal of a center of gravity analysis of weight balancing calculations configured according to embodiments of the present disclosure.

FIG. 15 is a screenshot of a weight balancing template displayed on the activity operator-input portal for entry of parameters used for weight balancing calculations configured according to embodiments of the present disclosure.

### DETAILED DESCRIPTION

The embodiments of the present disclosure describe a weight balancing function for a helicopter flight participant-input portal. As used herein, “tour”, “activity”, or “service” are used interchangeably to describe a helicopter trip activity organized by an organizing entity wherein a participant will need to sign up to participate or sign up with that organizing entity.

More specifically, the embodiments describe a weight balancing function for a helicopter flight participant-input portal that allows helicopter flight activity operators to configure a weight balancing functionality that collects weight data from the helicopter flight activity operator and helicopter flight activity participant and calculates weight balancing based on that data. These conditions allow for the helicopter flight participant-input portal to be dynamically change the number of available seats and/or the location of available seats as participants sign up for the helicopter flight. This is accomplished by the third party weight balancing functionality made available by the third party for customization by the helicopter flight activity operator.

This adds convenience for activity operators because this allows the activity operator to track estimated weight distribution as participants reserve their seats on the helicopter without having to manage the weight distribution and change the number of available seats and/or the locations of available seats on the helicopter flight participant-input portal themselves. This can be beneficial in a number of ways. For example, it frees up the activity operator to be able to focus on other important operator tasks as they do not have to do the weight distribution calculations and/or update the helicopter flight participant-input portal after each participant signs up. Additionally, weight distribution calculations involve analysis of many factors and some activity operators may not understand the complexity of the weight balancing process or may be too busy to stop what they are doing and concentrate on all of the relevant factors needed for a proper weight balancing analysis.

Accordingly, devices, systems, methods, and computer-readable media are discussed herein for providing, by a third party device, a weight balancing function for a participant-input portal, wherein the weight balancing function allows an activity operator to collect weight balancing data from the activity operator and from a prospective helicopter flight participant and then analyze the data to determine if an estimated weight distribution is within one or more threshold values. Then, with this information, change the number of seats available and/or location of available seats on the helicopter based on the weight distribution data analysis. As used herein, a “service party” or “activity operator” are used interchangeably to describe any person or entity that configures a participant-input portal and facilitates the operation of the helicopter flight activity associated with the activity listing displayed on the participant-input portal.

One method includes providing to an activity operator, by a third party device, an activity operator access portal to allow the activity operator to configure an activity participant-input portal that allows an activity participant to reserve a spot from a number of available spots open for an activity and enter information about the participant therein and providing, by a third party device, a weight balancing function to an activity operator to determine weight balancing for a number of passengers, crew, and equipment of a helicopter for a helicopter flight.

As used herein, the terns “third party device” refers to computing devices such as server computing devices, desktop computers, laptop computers, personal computers, mobile telephones, PDAs, and the like that are not operated or controlled by the activity operator or activity participant. In such a system, the third party creates a set of input portals (activity operator-input portal and activity participant-input portal) that allow the activity operator to access third party created tools to customize an activity participant-input portal via the activity operator-input portal.

In such an embodiment, the weight balancing function can be used to: allow the activity operator to select to add the weight balancing functionality to the activity operator's activity participant-input portal. Once selected, the third party created and operated software (i.e., executable instructions) queries the activity operator via the activity operator access portal for the activity operator to enter weight data including the helicopter type, fuel parameters, weight parameters, and flight details.

Further, the third party software allows each participant, via the activity participant-input portal, to enter weight data including the participant's weight. The third party software collects all weight data from the participants and activity operator. The third party software, then can determine: whether a particular passenger can participate in the activity, where on the helicopter they can be seated, change seats available on the participant-input portal and/or other weight balancing functions based on an analysis of the weight data.

In some embodiments, the method includes executing instructions in the third party software to allow the activity operator to select to add the weight balancing functionality to the activity operator's activity participant-input portal includes allowing the activity operator to select to add the weight balancing functionality from a list of functionality modules. Modules that are available can be any functionality having to do with booking an activity such as: reserving a spot in the activity, paying for the activity, reserving equipment, leaving a tip, collecting participant information, etc.

In various embodiments, the activity provider can be queried to provide helicopter type data such as: make, model, year, engine type, cabin layout, and/or customization features. Customization features, as discussed in more detail below, can be important as they can affect the weight balancing calculations if their effect on weight distribution or engine performance is substantial with respect to the weight balancing calculation.

In some embodiments, the activity provider can be queried (by the third party software) to provide fuel parameter data such as: fuel type, fuel burn rate, quantity of fuel, and/or fuel storage location. The activity provider can also be queried to provide weight parameter data such as: passenger weight, center of mass, crew weight, equipment weight, weight of items that are movable, and/or fuel weight. In various embodiments, the activity provider is queried (by the third party software) to provide flight detail data such as: weather, duration of flight, and/or distance to be flown.

The above types of information can be used to determine where in the helicopter each participant will sit based on the analysis of the weight data and/or to determine where in the helicopter each participant's baggage will sit based on the analysis of the weight data. The process for the determinations and types of data are discussed in more detail below.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

As used herein, “a number of” something may refer to one or more such things. For example, a number of activity vehicle options may refer to at least one activity vehicle option.

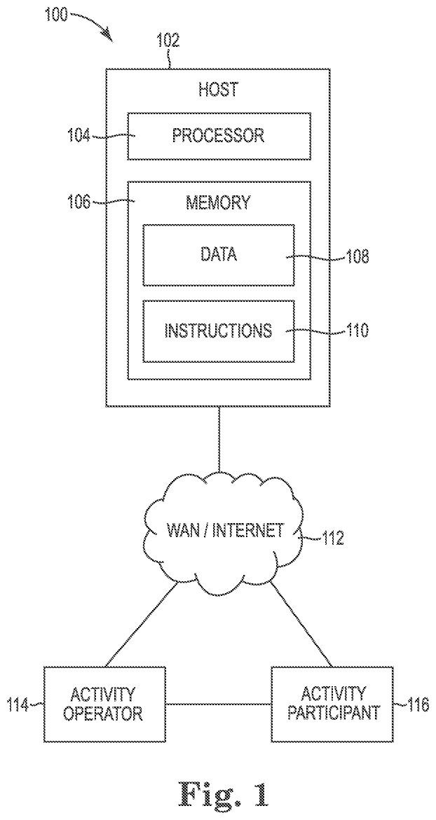

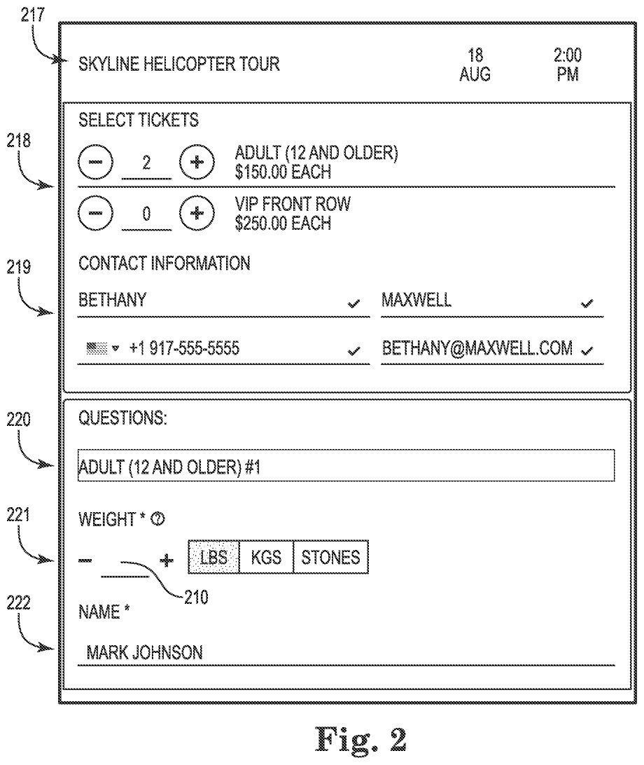

The figures herein follow a numbering convention in which the first digit or digits correspond to the figure number of the drawing and the remaining digits identify an element or component in the drawing. Similar elements or components between different figures may be identified by the use of similar digits. For example, reference numeral 104 may reference element “04” in FIG. 1, and a similar element may be referenced as 204 in FIG. 2.

FIG. 1 illustrates a functional block diagram of a computing system including at least one memory array featuring instructions for a weight balancing function for a configurable activity participant-input portal in accordance with a number of embodiments of the present disclosure. System 100 includes a computing device (e.g., a host 102) which features a processor 104 and memory 106. In some embodiments, the host 102 can be the third party computing device. The memory 106 includes information stored therein in the form of data 108 and/or executable instructions 110 that are executable by the processor. The data can be used or analyzed by the executable instructions to, for example, produce reports, analyze data to solve problems, such as weight balancing, or determine if software (also comprised of executable instructions) needs to be adjusted. System 100 also includes a connection to a wide area network (WAN) (e.g., the Internet 112), an activity operator-input portal 114 (e.g., accessed by an activity operator through an activity operator's computing device), and an activity participant-input portal 116 (e.g., accessed by an activity participant through an activity participant's computing device). In some embodiments, the third party device 102 (e.g., host) can host the activity operator-input portal 114 and the activity participant-input portal 116 on the third party device placing the access functionalities of the activity operator-input portal 114 and the activity participant-input portal 116 on the third party device 102.

The third party device 102 can include an interface, such as a touch screen, number pad, keyboard, or other method of interface to allow the third party to enter data into the third party device. Further, a host functionality can be implemented on the third party device such that the host functionality allows the third party device to provide the weight balancing function for the activity operator,

As used herein, “a processor” may be a number of processors, such as a parallel processing system, a number of coprocessors, etc. Example hosts may include, or be implemented in, server computing devices, desktop computers, laptop computers, personal computers, mobile telephones, PDAs, and the like. Such a host may be associated with a configurable software engine for automatically updating portions of a portal or tools used to create or customize a portal.

The processor 104 may execute instructions stored in a memory (e.g., memory 106) for providing a weight balancing function on an activity participant-input portal. In some embodiments, the activity participant-input portal acts as an activity booking portal. In some embodiments, the activity participant-input portal is an activity equipment booking portal. The activity participant-input portal may display a variety of activity or equipment listings. A configuration engine may be created by the third party, made available for access by the third part computing device, and may be used by the activity operator to modify the participant-input portal to customize the participant-input portal based on the selections made by the activity operator.

Once the participant-input portal is customized and configured to allow access by participants, the prospective participants may purchase spots for activities using the participant-input portal, or prospective participants may purchase the spots for activities by contacting the activity provider (activity operator) directly and the activity operator may enter the purchase details into the activity participant-portal on behalf of the activity participant. As used herein, a participant input portal may refer to a system that that serves as the interface where a participant may make purchases.

In serving as that interface, the participant-input portal may include a variety of features for the convenience of the participant and an activity operator. For example, in some embodiments, the participant-input portal may include activity listings in which portions of the activity listings can be automatically modified by a configuration engine.

The host can execute instructions 110 stored in the memory 106 to provide, by a third party device 102, a weight balancing function for an activity operator to collect a weight data from the activity operator and from a participant.

The activity operator can use the configuration engine to configure the participant-input portal to display the different weight data input and seat availability and/or location options to the activity participant.

The host can execute instructions 110 stored in the memory 106 to integrate the weight balancing function into the activity participant-input portal to allow one or more participants to each enter their weight data when registering for the helicopter flight. Further, the host can execute instructions 110 stored in the memory 106 to use the weight balancing function to in a customized manner, manage the weight balancing functions for each of several activity operators, for example, each having different helicopters, equipment, personnel, weather conditions, and/or flight routes. As used herein, the term “third party” refers to the person or entity that owns and/or operates the configuration engine that allows the activity operator to configure the participant-input portal.

One desirable implementation is where all of the activity portal customization and activity portal presentation functions regarding both the activity operator and activity participant portal are provided on the third party computing device and the activity operator and prospective participant access these functions from their own computing devices at their respective locations located remotely from the third party device. A discussion regarding various screens that may be viewable by the activity operator and/or prospective participant is provided below.

FIG. 2 is a screenshot of activity operator-configurable parameters for weight balancing displayed on the activities booking portal configured according to embodiments of the present disclosure. In this embodiment, a screen is shown that is provided by the third party, accessible for customization by the activity operator via the activity operator-input portal, and once customized accessible for reserving a seat for a helicopter flight by a prospective participant (a person wanting to reserve a seat on the helicopter flight) via the activity participant-input portal.

On this screen the items that can be customized include, the title of the helicopter flight 217, types of seats available and/or cost of a seat of a particular type at 218, contact information for the participant 219, any questions that the activity operator wants answered by the prospective participant 220, weight data such as amount of weight and units, information about, the participant 222, such as name, address, phone number, etc. The third party creates the format of each screen and allows the activity operator to select what information is presented on the screen.

For example, on the activity operator-input portal, a screen can provide a list of selectable types of seats from which the activity operator can select which seat types to present to the prospective participant. For instance, options could be selected from: adult, child, VIP, etc. One option could be that the activity operator can add their own seat type description which allows the activity operator the ability to customize how the seat types are described via their access to the activity operator-input portal.

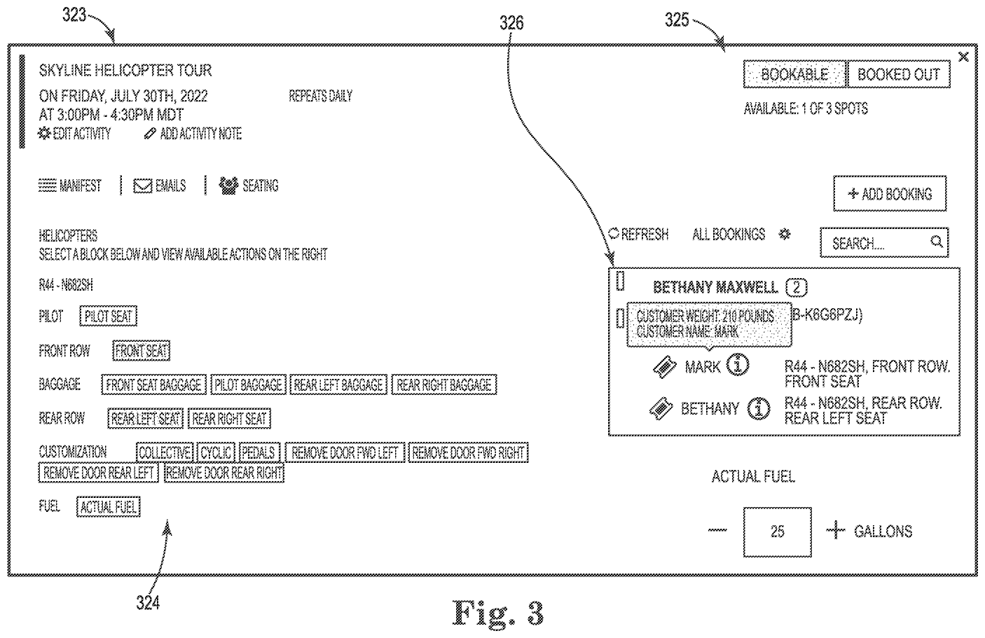

FIG. 3 is a screenshot of activity operator-configurable parameters for weight balancing displayed on the activity operator-input portal configured according to embodiments of the present disclosure. On this screen, the third party software has laid out a number of areas to provide information regarding the booking of a particular couple of participants (Bethany Maxwell and her companion Mark).

On this screen, the flight information 323 including activity operator's activity name (Skyline Helicopter Tour), date of activity, time of activity, and frequency of activity (repeats daily) is viewable by the activity operator. This can be beneficial to confirm the activity operator is looking at the correct activity and/or participants.

Types of information to by provided to the third party by the activity operator are illustrated at 324 and include information about: the helicopter type (the activity operator has provided (R44-N682SH as the helicopter identifier which, in some embodiments, will allow the third party software to look up the make, model, year, and other information from a helicopter registration list containing such information. This list may be on the third party device or at a government computing device having such registration details.), information about the pilot, seating information regarding the front row, information about baggage, seating information about the rear row, information about customization, and information about fuel. This information can include data collected from the activity operator-input portal and/or data collect from the participant via the activity participant-input portal.

Some of these areas have sub-classes of information to be filled in by the activity operator. For instance, the baggage information area includes: front seat baggage, pilot baggage, rear left baggage, and rear right baggage. The rear row of this helicopter includes two seats, so the information includes data for the left and right rear seats. And, is shown, the customization information section can have a number of sub-classes of information, such as: collective information, cyclic information, pedal information, and/or door removal information, among other customization options available on different helicopter makes and models.

The screen also includes the booking status 325 of the helicopter flight. In this illustration, the flight has three total spots that can be booked and one of them is still available. Accordingly, the bookable tab is shaded, indicating that participants can still book a seat on the particular flight (as indicated at 323).

Also included, is information about the participants booked on the flight 326. This information is viewable on the activity operator-input portal and can help to plan the flight, compute the weight distribution, and/or assist the activity operator in refining the customization of the activity participant-input portal, among other uses for such information. Information that can be included about the participants can, for example, include: participant's name, participant and/or booking group identifier (e.g., B-K6G6PZJ), helicopter identifier (e.g., in part of a group that booked together, but on different helicopter), row description, seat description, and/or weight. As can be seen in FIG. 3, the activity operator can select a name (e.g., select “Mark”) and see additional information about that particular participant (e.g., participant name, participant weight, and/or baggage weight, etc.).

Also included in this section is a search function, allowing the activity operator to search for booking information. For example, the search function can search: by helicopter identifier, participant group identifier, participant identifier, or other criteria regarding the flight or participant.

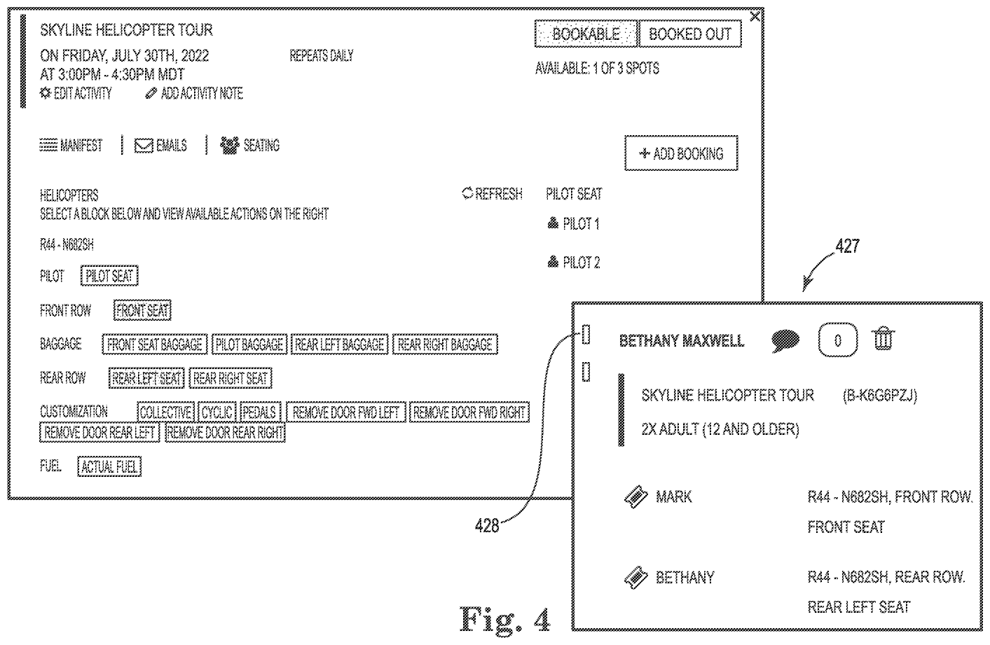

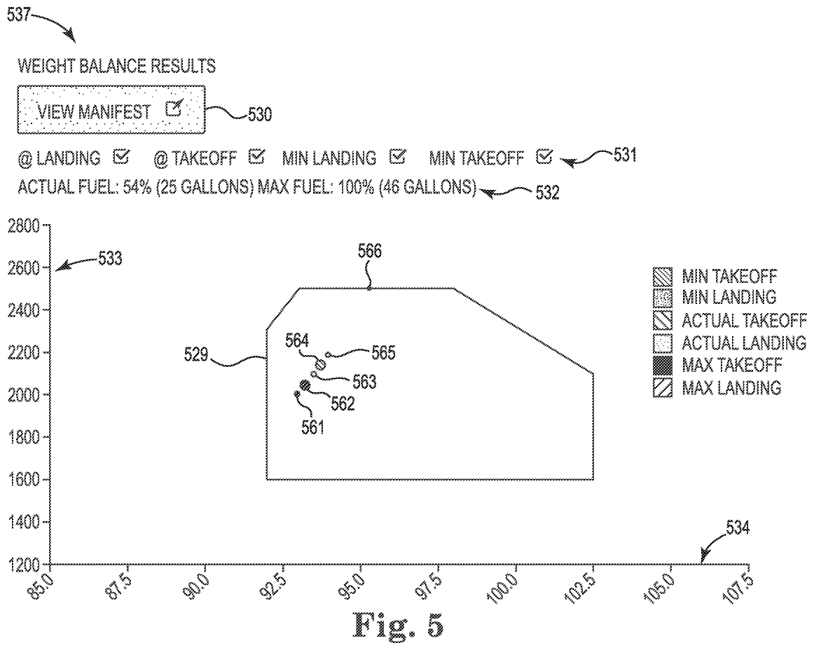

FIG. 4 is a screenshot of additional activity operator-configurable parameters for weight balancing displayed on the activity operator-input portal configured according to embodiments of the present disclosure. Additional information can be provided about the participant 427 when their name is selected, as shown in FIG. 4. This view shows the number of people that booked in a group 428 (the two rectangular symbols indicate two bookings in the group identified as (B-K6G6PZJ). As with the information in FIG. 3, this information is viewable on the activity operator-input portal and can help to plan the flight, compute the weight distribution, and/or assist the activity operator in refining the customization of the activity participant-input portal, among other uses for such information. Information that can be included about the participants can, for example, include: participant's name, participant and/or booking group identifier (e.g., B-K6G6PZJ), tour identifier (e.g., Skyline Helicopter Tour), types of participants in the booking group (e.g., 2× Adult), helicopter identifier, row description, and/or seat description. Once the weight data is provided by the activity operator and participants, a weight distribution calculation can be made. As used herein, weight distribution is the distribution of weight of the aircraft and weight balancing is the process of changing the weight distribution. FIG. 5 illustrates a weight distribution that can be used in such a weight balancing process.

FIG. 5 is a screenshot of a report displayed on the activity operator-input portal of an initial weight balancing analysis for takeoff and landing weight balancing calculations configured according to embodiments of the present disclosure. In this report, a graph 537 shows a polygonal boundary 529 that indicates the safe operational thresholds of weight balancing based on weight 533 versus arm distance 534 from the center of gravity. The dots within the polygon indicate the weight distribution at different phases of the helicopter flight. The phases include minimum takeoff 563, minimum landing 561, actual takeoff 564, actual landing 562, maximum takeoff 566, and maximum landing 565. As indicated, all of these data points (dots) are within the operational thresholds meaning that operating the flight based on the provided data should be safe conditions for a flight with respect to weight balancing.

This screen also includes a button 530 that can be selected to view the flight manifest. The manifest can be helpful to confirm that the manifest includes complete and correct data, indicating that the report is correct. The screen also includes toggle boxes 531 that can allow the activity operator to select the data to be shown on the graph. Additionally, since fuel amount and fuel consumption are such important parts of the data calculation and flight management, the actual fuel planned for the flight and the maximum fuel amounts are provided on this screen for the benefit of the activity operator to see how close to the maximum the flight will be.

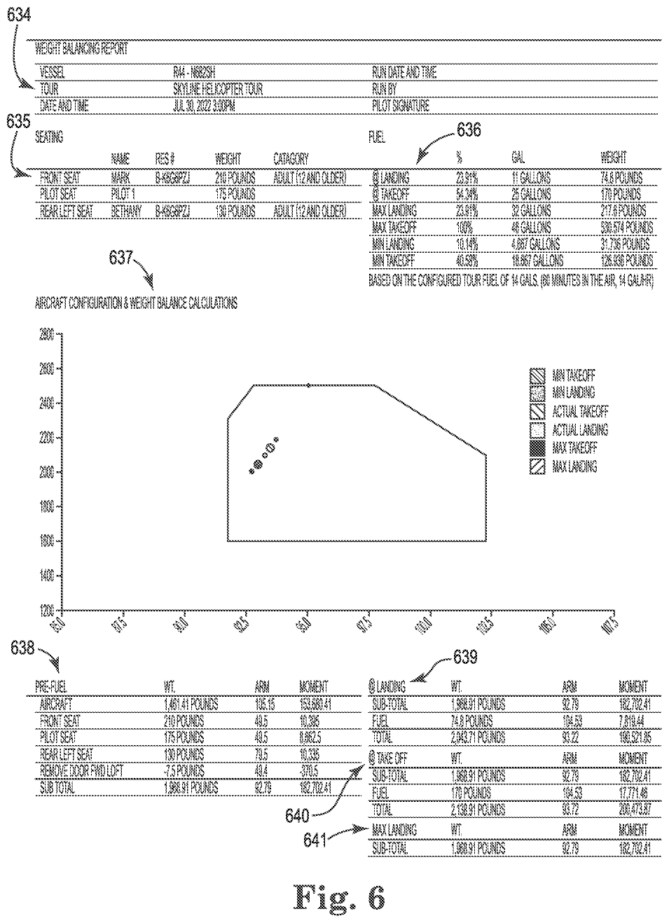

FIG. 6 is a screenshot of another report displayed on the activity operator-input portal of an initial weight balancing analysis for takeoff and land weight balancing calculations configured according to embodiments of the present disclosure. FIG. 6 provides the details that were involved in the calculation of the weight distribution of graph 637. This screen may be the detail shown on the manifest for the flight.

The details include the particular flight details, such as the vessel identifier, activity name, date and time of the flight, run date of this report, name of person that prepared and ran the report, and pilot signature. This information can be used for audit purposes to assure the information has been completed, the preparer is competent, and that the pilot has reviewed this data and understood the parameters of the weight distribution of this particular flight.

The seating information is provided at 635, wherein the information includes pilot and participant identification and weight data. For example, the names of the participants, their individual or group identifiers, their and the pilot's weights, and the category of the booking type (Adult).

At 636, the report provides fuel parameters at different times during the flight. These parameters include: estimated actual fuel at landing, estimated actual fuel at takeoff, maximum fuel at landing, maximum fuel at takeoff, minimum fuel at landing, and minimum fuel at takeoff. This information is important in determining whether the helicopter will fall within the threshold polygon.

The information included is the percentage of fuel available at different points during the flight, amount of fuel at that point, and the weight of that fuel for purposes of the weight balancing calculations. Also included, is information about the specific fuel need estimates for this particular flight, so that the activity operator can confirm this information about fuel need, duration of flight, and estimated fuel consumption (e.g., total fuel consumption of 14 gallons, 60 minutes for the flight, at 14 gal/hr.).

Also included is pre-flight weight information at 638. This information includes: weight, distance from the arm as discussed below, and the moment related to the center of gravity for the: aircraft, front seat participant, pilot, rear left seat participant, and any helicopter modifications (e.g., remove door fwd loft). These details are itemized and totaled to aid the activity operator in confirming the calculations are complete and correct.

The estimated landing information 639 including the pre-fuel weight data from 638 and the fuel at landing from 636 including weight, distance from the arm as discussed below, and the moment related to the center of gravity. At 640, the estimated takeoff information for this particular flight is shown including the pre-fuel weight data from 638 and the fuel at takeoff from 636 including weight, distance from the arm as discussed below, and the moment related to the center of gravity. Additionally, the maximum landing information 641 including the pre-fuel weight data from 638 and the fuel at landing from 636 including weight, distance from the arm as discussed below, and the moment related to the center of gravity.

Based on this data and these calculations, the third party software offers the activity operator a sophisticated approach to helicopter weight balancing on the third party computing device. For example, an apparatus according to an embodiment of the present disclosure includes:
a computing device having a processor and a memory, wherein the computing device executes instructions stored in the memory to:
   provide to an activity operator, by a third party device, an activity operator access portal to allow the activity operator to configure an activity participant-input portal that allows an activity participant to reserve a spot from a number of available spots open for an activity and enter information about the participant therein;
   provide, by a third party device, a weight balancing function to an activity operator to determine weight balancing for a number of passengers, crew, and equipment of a helicopter for a helicopter flight; and
   using the weight balancing function to:
      allow the activity operator to select to add the weight balancing functionality to the activity operator's activity participant-input portal;
      once selected, query the activity operator via the activity operator access portal for the activity operator to enter weight data including the helicopter type, fuel parameters, weight parameters, and flight details;
      allow each participant, via the activity participant-input portal, to enter weight data including the participant's weight;
      the third party, collecting all weight data from the participants and activity operator; and
      the third party, determining whether a particular passenger can participate in the activity based on an analysis of the weight data.

As discussed below, the weight balancing function can be used to determine a shift in a center of gravity as fuel is used during flight. Further, the weight balancing function can be used to determine whether a center of gravity is located outside a threshold safe area. This calculation of the weight balancing function can then be used to determine whether the flight can be undertaken based on analysis of the weight data. For example, the weight balancing function can be used to provide reasons for why the flight cannot be undertaken. The weight balancing function can also be used to provide solutions to the reasons for why the flight cannot be undertaken.

In another embodiment, a non-transitory computer-readable medium having instructions stored thereon which, when executed by a processor, cause the processor to:
provide to an activity operator, by a third party device, an activity operator access portal to allow the activity operator to configure an activity participant-input portal that allows an activity participant to reserve a spot from a number of available spots open for an activity and enter information about the participant therein;
provide, by a third party device, a weight balancing function to an activity operator to determine weight balancing for a number of passengers, crew, and equipment of a helicopter for a helicopter flight; and
using the weight balancing function to:
   allow the activity operator to select to add the weight balancing functionality to the activity operator's activity participant-input portal;
   once selected, query the activity operator via the activity operator access portal for the activity operator to enter weight data including the helicopter type, fuel parameters, weight parameters, and flight details;
   allow each participant, via the activity participant-input portal, to enter weight data including the participant's weight;
   the third party, collecting all weight data from the participants and activity operator; and
   the third party, determining whether a particular passenger can participate in the activity based on an analysis of the weight data.
providing, to the activity operator, a report that includes information about a status of the weight balancing based on the analysis of the weight data.

In various embodiments, the activity provider can be queried to provide weight parameter data including at least one of helicopter weight without fuel and helicopter weight limit at takeoff. Some embodiments include the status of the weight balancing including locations of movable weight items. The status of the weight balancing can include locations of suggestions regarding repositioning of movable weight items based on the analysis of the weight data. The status of the weight balancing can also include a determination regarding whether the flight can be undertaken based on the analysis of the weight data.

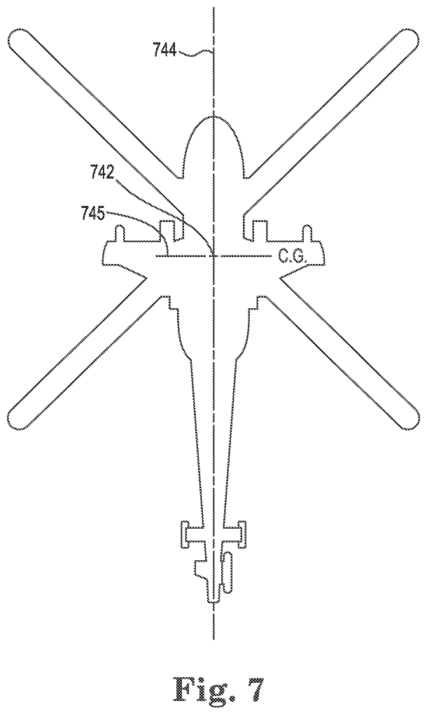

FIG. 7 is a depiction of an example of a center of gravity analysis performed according to embodiments of the present disclosure. In calculation of the center of gravity 742, the analysis can be undertaken in two directions: across the width of the helicopter 745 and/or along the length of the helicopter 744. As the change in center of gravity is influenced by the changes along the length of the helicopter, most of the discussion below will be regarding this aspect of the change in the center of gravity.

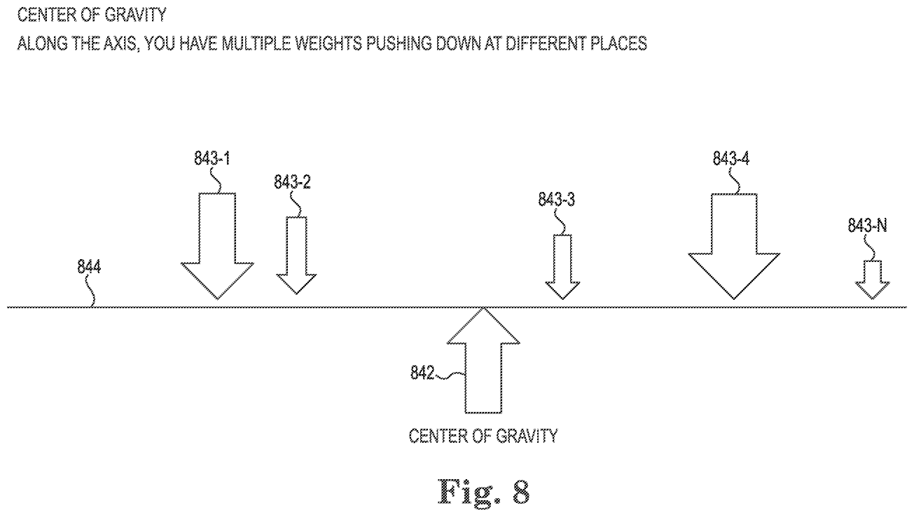

FIG. 8 is another depiction of an example of a center of gravity analysis performed according to embodiments of the present disclosure. Here, along the length of the helicopter 844, there are a number of items 843-1 to 843-N that are affecting the center of gravity 842 of the helicopter. As discussed above, the items can be 843-1 to 843-N participant weights, pilot weight, baggage, and fuel, among other items. Additionally, removal of doors and/or other modifications that remove weight can be viewed as upward arrows along the length of the helicopter that counteract some of the weight added along the length of the helicopter and these changes need to be considered when determining the center of gravity.

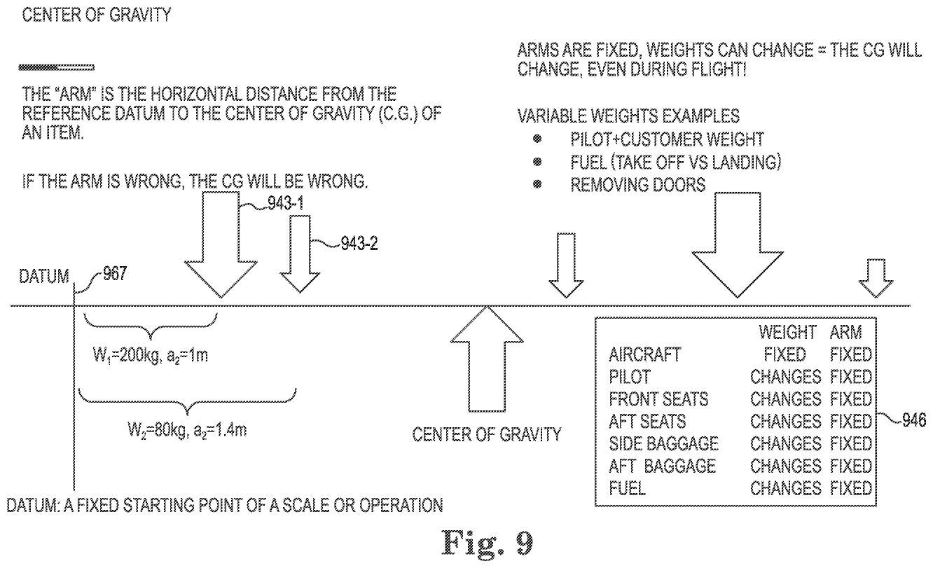

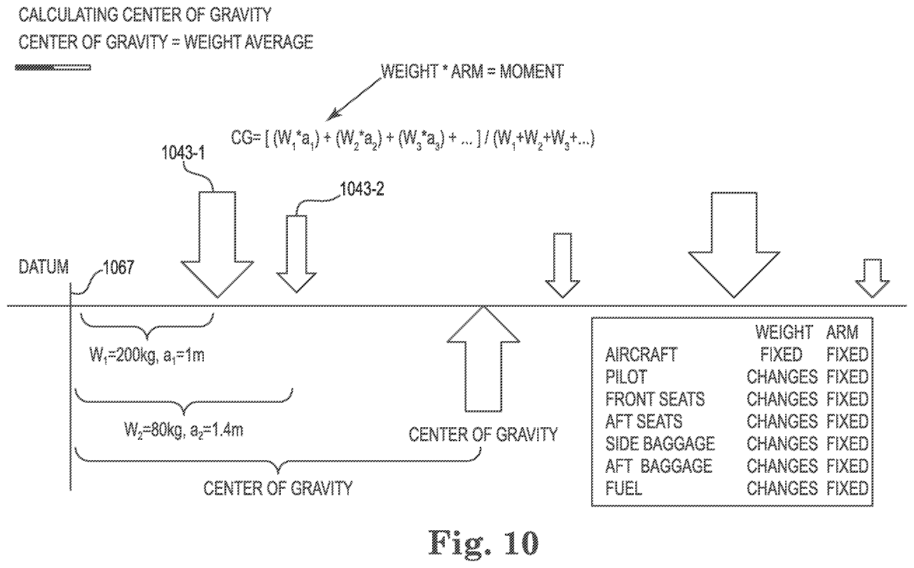

FIG. 9 is another depiction of an example of a center of gravity analysis performed according to embodiments of the present disclosure. The example provides more detail about the center of gravity analysis. As described on this figure, the “arm” as described herein is the distance from a referenced known starting point 967 (i.e., a datum) to a weight 943-1 or 943-2 (e.g., participant's weight in a front row seat) resulting in a change to the center of gravity. The arm (e.g., the front row seat location) is fixed, but the weight (e.g., participant sitting in that seat) can change. Another example is the fuel tank location is fixed, but the fuel weight in that tank will change as fuel is consumed. A list of fixed and variable parameters is provided at 946. In this example, the weight 943-1 has a weight W₁ of 200 kilogram (kg) an arm at a distance from the datum of 1 meter (m). The weight at 943-2 is a W₂ of 80 kg an arm of 1.4 m from the datum. The calculation that uses this data is discussed further in FIG. 10.

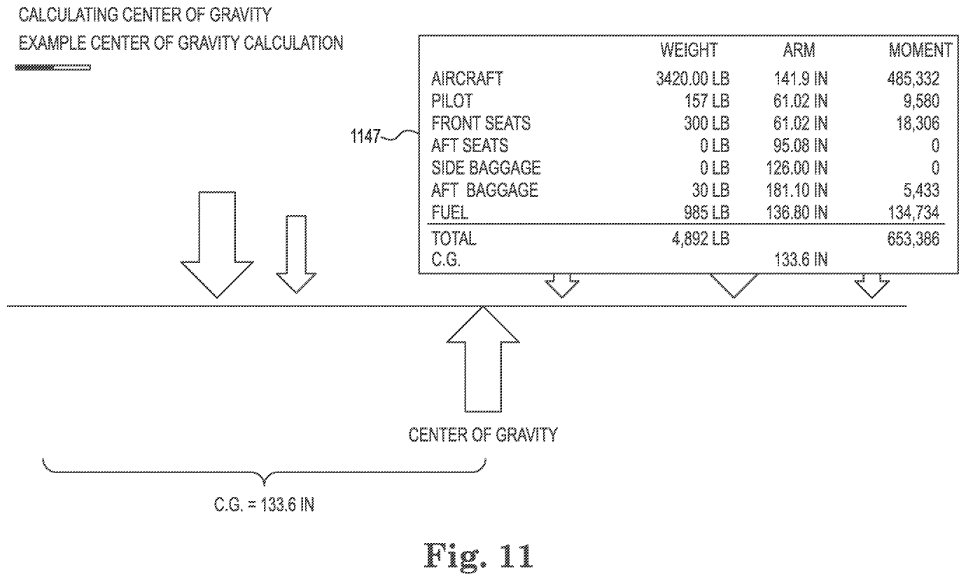

FIG. 10 is another depiction of an example of a center of gravity analysis performed according to embodiments of the present disclosure. In this example, the weight 943-1 has a weight W₁ of 2.00 kg at a distance from the datum 1067 of 1 meter (m). The weight at 943-2 is a W₂ of 80 kg a 1.4 m from the datum. In these calculations, the weight*arm=moment and the sum of these moments divided by the sum of the weights is center of gravity. For example, the moment of item 1043-1 is 200 kg*1 m=200 kgm and the moment of 1043-2 is 80 kg*1.4 m=112 kgm. Once the arm and moments are calculated, the center of gravity can be calculated based on the formula depicted in FIG. 10 and such calculations are shown in FIG. 11.

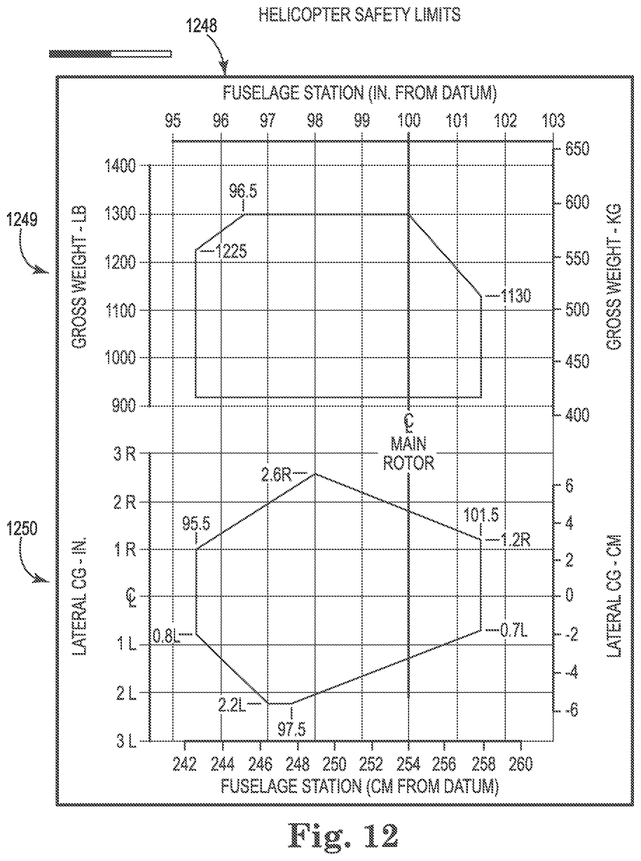

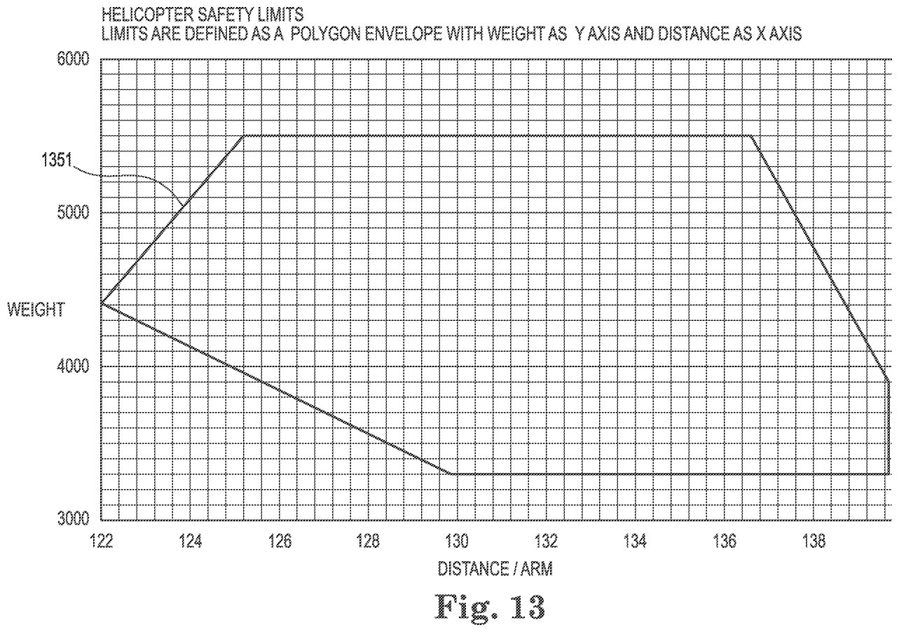

FIG. 11 is another depiction of an example of a center of gravity analysis performed according to embodiments of the present disclosure. In this example, the arm and moment are calculated at 1147 based upon the weight data provided by the participants and the activity operator via their respective portals. The moments are then totaled, and the center of gravity calculated based on the formula presented in FIG. 10. From this information, a polygon defining the thresholds for permissible flights is created. This threshold information can then be provided to the activity operator, for example as a graph such as those illustrated in FIGS. 12 and 13

FIG. 12 is a screenshot of a report displayed on the activity operator-input portal of a center of gravity analysis of weight balancing calculations configured according to embodiments of the present disclosure. In this example, a safety limit report 1248 is provided and includes a graph of gross weight versus arm at 1249 and center of gravity location change to the left or right of the initial center of gravity location versus arm at 1250. This information can be beneficial to the activity provider to determine if the flight is safe to go forward.

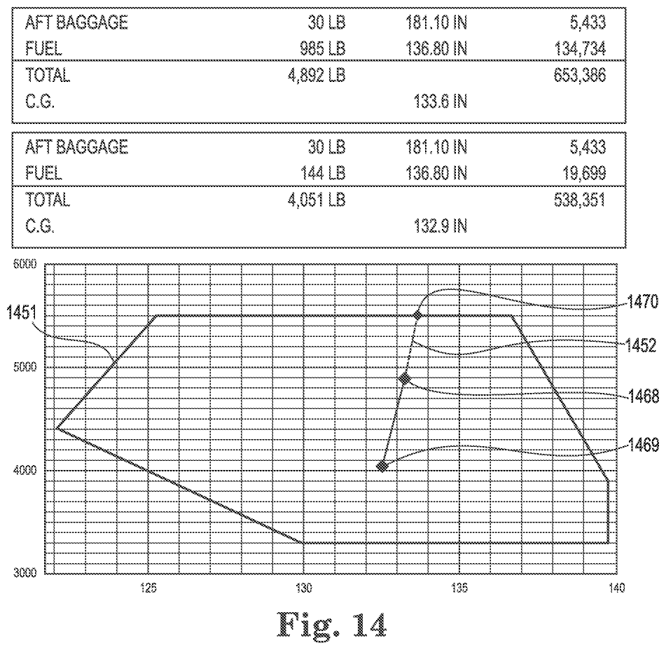

FIG. 13 is a screenshot of another report displayed on the activity operator-input portal of a center of gravity analysis of weight balancing calculations configured according to embodiments of the present disclosure. In this example, a safety limit polygon is shown which is created with weight versus arm. This polygon is then used in the more detailed report shown in FIG. 14.

FIG. 14 is a screenshot of another report displayed on the activity operator-input portal of a center of gravity analysis of weight balancing calculations configured according to embodiments of the present disclosure. In this report, aft baggage and actual estimated fuel (e.g., takeoff=985 lbs. and landing=144 lbs.) are added as part of the weight balancing process wherein the weight is shown for each item and the arm and moment adjustments are calculated for each item.

The safety threshold polygon of FIG. 13 is used at 1451 and then these adjusted values are plotted at 1452 against the polygon to ensure that the takeoff and landing calculations are within the polygon. This plot is shown in FIG. 14, where the polygon 1451 includes estimated actual takeoff weight 1468, estimated actual landing weight 1469, and a calculation of maximum takeoff weight (full fuel load), not shown. The calculation of the maximum ensures that if more fuel is added to the flight, that it will not put the safety of the flight in jeopardy or allows the activity operator to know that the flight will be outside or inside the safety thresholds and whether special attention needs to be paid to the adding of fuel for the flight.

In some embodiments, a calculation of where the intersection with the threshold at 1470 is located. This can be used by the activity operator to understand what the weight limit would be for the flight.

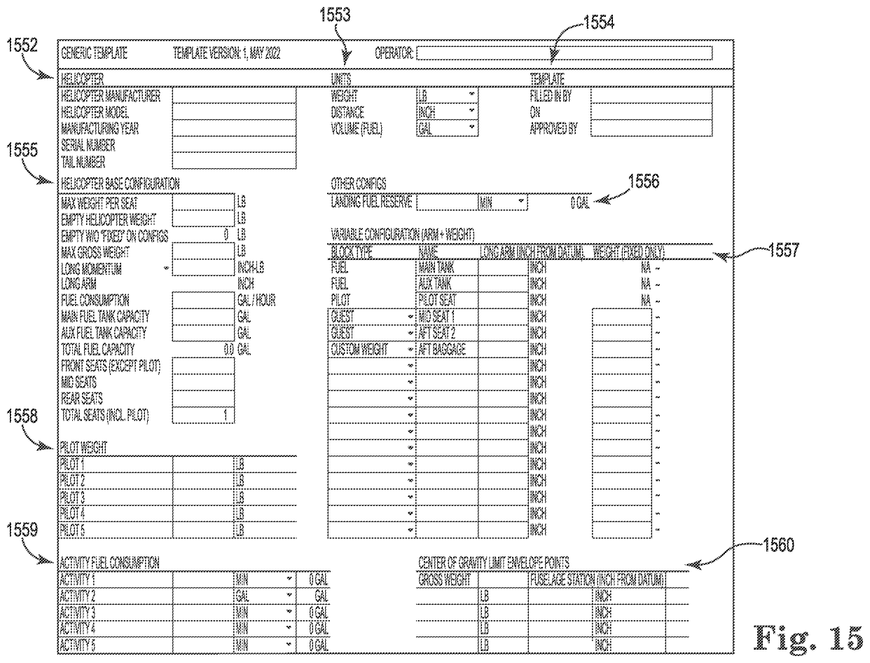

FIG. 15 is a screenshot of a weight balancing template displayed on the activity, operator-input portal for entry of parameters used for weight balancing calculations configured according to embodiments of the present disclosure. This template is to be filled out by the activity operator via the activity operator-input portal. The data provided includes helicopter data such as manufacturer, model, manufacturing year, serial number, and/or tail number among other helicopter data that may be useful in providing a weight balancing functions.

The activity operator also defines the units for the data being entered at 1553. Additionally, audit information can be entered, such as identification of the person that filled in this template, when it was completed, and when the data was approved. This information can be used to determine if the information is complete and that the calculations are correct.

The template includes a section for the helicopter's base configuration that, for example, can include: maximum weight per seat, empty helicopter weight, empty w/o “fixed” on configuration items, maximum gross weight, long momentum, long arm, fuel consumption, main fuel tank capacity, auxiliary fuel tank capacity, front seat weight, middle seat weight, rear seat weight, and total seat weight including pilot, among other base configuration items that would be useful to the weight balancing calculations.

A section is also provided where other configuration items can be included for the weight balancing calculations. For example, a landing fuel reserve item is included at 1556.

The variable configuration items are entered at 1557. They can, for example, include: fuel in the main tank, fuel in the auxiliary tank, pilot weight, participant weights, baggage weights, and other customizable weight adjustments. In this section, the arm and weight data can be provided by the activity operator and/or by the third party software, if the participant data has been entered by the participant.

The template in FIG. 15 also includes a section at 1558 for entry of pilot information. This information can, for example, include pilot name, pilot identifier, pilot weight among other information that would be helpful in calculating weight balancing.

Also included is a section to collect fuel consumption estimates for the flight activities. This section can include values for a single activity or multiple activities, if the flight has multiple legs, for example.

The template of FIG. 15 also has a section for identifying the center of gravity calculation points. These points can, for example, include gross weight and distance from the datum for each gross weight item.

Based on the data collected in this template, which is provided to the activity operator-input portal via the software on the third party computing device for entry of some or all of the data by the activity operator, the third party software can calculate the weight distribution for a particular flight with a particular helicopter, pilot; and participant weight characteristics. These calculations can then be provided to the activity operator for consideration as to whether to goo forward with the flight.

This information can be provided to the activity operator in the form of reports, for instance, presented on a screen of a computing devices used by the activity operator. In some embodiments, if the data determined that the flight weight balancing put the flight data outside of the safety threshold polygon, then the third party software can identify one or more issues causing the flight data to fall outside one of the thresholds and provide this information in the reporting to the activity provider. In various embodiments, the third party software can also provide recommendations for addressing the one or more issues causing the flight data to fall outside one of the thresholds.

For example, the third party software could recommend reducing the baggage, reducing the number of participants allowed to book a spot on the flight, change the seat one or more participants (swapping the seats of an 80 kg participant and a 200 kg participant), changing the amount of fuel in the main and auxiliary tanks, among other recommendations that can be useful to effect the weight distribution. The activity provider can then make changes to the data to perform weight balancing and recalculate to ensure that the flight data is within the threshold polygon for that particular flight.

Additionally, if the activity operator decides that the number of spots on the flight needs to be reduced, the activity operator can manually reduce the spots via the activity operator-input portal. Alternatively, the third party software can reduce the number of spots automatically at the direction of the activity operator. Further, in some embodiments, if it is possible that another participant can be booked, but that they may need to meet a weight requirement, the booking listing can include a note indicating that the spot has a weight limit (e.g., “participant must be 80 kg or less” or “participant must not have any baggage”).

The embodiments of the present disclosure provide tools for activity operators to handle complex helicopter weight balancing without the expertise and allow the activity operator to customize an activity participant-input portal to include a weight balancing functionality and tools to address weight balancing issues. The embodiments also allow the third party to manage weight balancing for multiple activity operators each having made different customization choices to change the activity participant-input portal.

In the above detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

It is to be understood that the terminology used herein is for the purpose of describing particular embodiments only and is not intended to be limiting. As used herein, the singular forms “a”, “an”, and “the” include singular and plural referents, unless the context clearly dictates otherwise, as do “a number of”, “at least one”, and “one or more” (e.g., a number of occupied participant spots may refer to one or more occupied participant spots), whereas a “plurality of” is intended to refer to more than one of such things.

Furthermore, the words “can” and “may” are used throughout this application in a permissive sense (i.e., having the potential to, being able to), not in a mandatory sense (i.e., must). The term “include,” and derivations thereof, means “including, but not limited to”.

Although specific embodiments have been illustrated and described herein, those of ordinary skill in the art will appreciate that an arrangement calculated to achieve the same results may be substituted for the specific embodiments shown. This disclosure is intended to cover adaptations or variations of one or more embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed embodiment. Thus, the following claims are hereby, incorporated into the Detailed Description, with each claim standing on its own as a separate embodiment.

What is claimed:

1. A method, comprising:
providing to an activity operator, by a third party device, an activity operator access portal to allow the activity operator to configure an activity participant-input portal that allows an activity participant to reserve a spot from a number of available spots open for an activity and enter information about the participant therein;
providing, by a third party device, a weight balancing function to an activity operator to determine weight balancing for a number of passengers, crew, and equipment of a helicopter for a helicopter flight; and
using the weight balancing function to:
allow the activity operator to select to add the weight balancing functionality to the activity operator's activity participant-input portal;
once selected, query the activity operator via the activity operator access portal for the activity operator to enter weight data including the helicopter type, fuel parameters, weight parameters, and flight details;
allow each participant, via the activity participant-input portal, to enter weight data including the participant's weight;
the third party, collecting all weight data from the participants and activity operator; and
the third party, determining whether a particular passenger can participate in the activity based on an analysis of the weight data.

2. The method of claim 1, wherein allowing the activity operator to select to add the weight balancing functionality to the activity operator's activity participant-input portal includes allowing the activity operator to select to add the weight balancing functionality from a list of functionality modules.

3. The method of claim 1, wherein the activity provider is queried to provide helicopter type data including at least one of make, model, year, engine type, cabin layout, and customization features.

4. The method of claim 1, wherein the activity provider is queried to provide fuel parameter data including at least one of fuel type, fuel burn rate, quantity of fuel, and fuel storage location.

5. The method of claim 1, wherein the activity provider is queried to provide weight parameter data including at least one of passenger weight, center of mass, crew weight, equipment weight, weight of items that are movable, and fuel weight.

6. The method of claim 1, wherein the activity provider is queried to provide flight detail data including at least one of weather, duration of flight, and distance to be flown.

7. The method of claim 1, further comprising to determine where in the helicopter each participant will sit based on the analysis of the weight data.

8. The method of claim 1, further comprising to determine where in the helicopter each participant's baggage will sit based on the analysis of the weight data.

9. An apparatus, comprising:
a computing device having a processor and a memory, wherein the computing device executes instructions stored in the memory to:
provide to an activity operator, by a third party device, an activity operator access portal to allow the activity operator to configure an activity participant-input portal that allows an activity participant to reserve a spot from a number of available spots open for an activity and enter information about the participant therein;
provide, by a third party device, a weight balancing function to an activity operator to determine weight balancing for a number of passengers, crew, and equipment of a helicopter for a helicopter flight; and
using the weight balancing function to:
allow the activity operator to select to add the weight balancing functionality to the activity operator's activity participant-input portal;
once selected, query the activity operator via the activity operator access portal for the activity operator to enter weight data including the helicopter type, fuel parameters, weight parameters, and flight details;
allow each participant, via the activity participant-input portal, to enter weight data including the participant's weight;
the third party, collecting all weight data from the participants and activity operator; and
the third party, determining whether a particular passenger can participate in the activity based on an analysis of the weight data.

10. The apparatus of claim 9, wherein the weight balancing function is used to determine a shift in a center of gravity as fuel is used during flight.

11. The apparatus of claim 9, wherein the weight balancing function is used to determine whether a center of gravity is located outside a threshold safe area.

12. The apparatus of claim 9, wherein the weight balancing function is used to determine whether the flight can be undertaken based on analysis of the weight data.

13. The apparatus of claim 12, wherein the weight balancing function is used to provide reasons for why the flight cannot be undertaken.

14. The apparatus of claim 13, wherein the weight balancing function is used to provide solutions to the reasons for why the flight cannot be undertaken.

15. A non-transitory computer-readable medium having instructions stored thereon which, when executed by a processor, cause the processor to:
provide to an activity operator, by a third party device, an activity operator access portal to allow the activity operator to configure an activity participant-input portal that allows an activity participant to reserve a spot from a number of available spots open for an activity and enter information about the participant therein;
provide, by a third party device, a weight balancing function to an activity operator to determine weight balancing for a number of passengers, crew, and equipment of a helicopter for a helicopter flight; and
using the weight balancing function to:
allow the activity operator to select to add the weight balancing functionality to the activity operator's activity participant-input portal;
once selected, query the activity operator via the activity operator access portal for the activity operator to enter weight data including the helicopter type, fuel parameters, weight parameters, and flight details;
allow each participant, via the activity participant-input portal, to enter weight data including the participant's weight;
the third party, collecting all weight data from the participants and activity operator; and
the third party, determining whether a particular passenger can participate in the activity based on an analysis of the weight data.

16. The medium of claim 15, further comprising providing, to the activity operator, a report that includes information about a status of the weight balancing based on the analysis of the weight data.

17. The medium of claim 15, wherein the activity provider is queried to provide weight parameter data including at least one of helicopter weight without fuel and helicopter weight limit at takeoff

18. The medium of claim 16, wherein the status of the weight balancing includes locations of movable weight items.

19. The medium of claim 18, wherein the status of the weight balancing includes locations of suggestions regarding repositioning of movable weight items based on the analysis of the weight data.

20. The medium of claim 15, wherein the status of the weight balancing includes a determination regarding whether the flight can be undertaken based on the analysis of the weight data.
